(19) United States
(12) Patent Application Publication
(10) Pub. No.: US 2009/0151666 A1
(43) Pub. Date: Jun. 18, 2009

(54) VARIABLE VALVE TIMING APPARATUS

(75) Inventor: Do Sun CHOI, Hwaseong-city (KR)

Correspondence Address: MORGAN, LEWIS & BOCKIUS LLP (SF), One Market, Spear Street Tower, Suite 2800, San Francisco, CA, 94105, US

(73) Assignee: Hyndai Motor Company, Seoul (KR)

(21) Appl. No.: 12/243,114

(22) Filed: Oct. 1, 2008

(30) Foreign Application Priority Data
Dec. 14, 2007 (KR) 10-2007-0131648

(51) Int. Cl. F01L 9/04; F16K 31/08

(52) U.S. Cl. 123/90.11; 251/65

(57) ABSTRACT

A variable valve lift apparatus is mounted above a valve stem of a valve for opening and closing the valve. The apparatus includes an upper and a lower housing; an upper electromagnet in the upper housing; a lower electromagnet in the lower housing; at least one permanent magnet that penetrates the electromagnets; an upper plate between the permanent magnet and the upper housing; and a lower plate between the permanent magnet and the lower housing, which opens and closes the valve. The apparatus may also include an upper coil spring assembly mounted in the upper housing, and a lower coil spring assembly mounted in the lower housing, each coil spring assembly including at least two coil springs. The apparatus may also include an upper damper at the top of the upper housing, and a lower damper at the bottom of the lower housing. Oil may be provided in the housings.

### CROSS-REFERENCE TO RELATED APPLICATION

This application claims priority to, and the benefit of, Korean Patent Application No. 10-2007-0131648, filed in the Korean Intellectual Property Office on Dec. 14, 2007, the entire contents of which are incorporated herein by reference.

### BACKGROUND OF THE INVENTION

(a) Field of the Invention

The present invention relates to an engine of a vehicle. More particularly, the present invention relates to a variable valve timing apparatus of an engine.

(b) Description of the Related Art

An internal combustion engine generates power by burning a mixture of air and fuel in a combustion chamber. Intake valves are operated by a camshaft in order to intake the air, and the air is drawn into the combustion chamber while the intake valves are open. In addition, exhaust valves are operated by the camshaft, and exhaust gas is expelled from the combustion chamber while the exhaust valves are open.

Optimal opening/closing timing of the intake and exhaust valves depends on the rotation speed of the engine. Variable valve lift (VVL) apparatus have therefore been developed. These apparatus allow different valve timing depending on the engine speed.

A VVL apparatus is usually operated by a camshaft by using hydraulic pressure, but electromechanical valve (EMV) apparatus are increasingly being used, in which the valves are operated by applying an electromagnetic force generated by an electromagnet to a steel core or a steel armature. If the electromagnetic force were utilized more effectively the EMV apparatus could be smaller, more precise, and more responsive.

The above information disclosed in this Background section is only for enhancement of understanding of the background of the invention and therefore it may contain information that does not form the prior art that is already known in this country to a person of ordinary skill in the art.

### SUMMARY OF THE INVENTION

A variable valve lift apparatus is mounted above a valve stem of a valve for opening and closing the valve. The apparatus includes an upper and a lower housing, an upper electromagnet in the upper housing, a lower electromagnet in the lower housing, at least one permanent magnet that penetrates the electromagnets, an upper plate between the permanent magnet and the upper housing, and a lower plate between the permanent magnet and the lower housing. The lower plate opens and closes the valve.

The apparatus may also include an upper coil spring assembly mounted in the upper housing, and a lower coil spring assembly mounted in the lower housing, each coil spring assembly including at least two coil springs.

The apparatus may also include an upper damper at the top of the upper housing, and a lower damper at the bottom of the lower housing.

Oil may be provided in the housings.

Another aspect of the present invention is directed to a variable valve apparatus of an engine including an upper housing and a lower housing, an upper coil that is fixed within the upper housing, a lower coil that is fixed within the lower housing, a permanent magnet that penetrates the upper coil and the lower coil, a valve having a valve stem positioned below the permanent magnet, an upper plate that is positioned above the permanent magnet, and a lower plate that is positioned between the permanent magnet and the valve stem.

The variable valve apparatus may further include an upper coil spring assembly that is mounted exterior to an outer circumference of the upper coil and between the upper plate and a bottom side of the upper housing, and a lower coil spring assembly that is mounted exterior to an outer circumference of the lower coil and between the lower plate and a top side of the lower housing. The upper coil spring assembly and the lower coil spring assembly may be formed as a dual spring structure having interior and exterior coil springs. The variable valve apparatus may further include an upper damping device arranged at an upper interior surface of the upper housing, and a lower damping device arranged at a lower interior surface of the lower housing. The upper housing and the lower housing may be filled with oil. Also, a damping effect may be generated by the oil when the upper plate moves and when the lower plate moves.

### BRIEF DESCRIPTION OF THE DRAWINGS

FIG. 1 is a schematic, cross-sectional diagram of a variable valve apparatus according to an exemplary embodiment, with the valve closed.

FIG. 2 is a view similar to that of FIG. 1, with the valve open.

FIG. 3 is a schematic, cross-sectional diagram of another exemplary variable valve apparatus, with the valve closed.

### DETAILED DESCRIPTION OF PREFERRED EMBODIMENTS

An exemplary embodiment of the present invention will hereinafter be described in detail with reference to the accompanying drawings.

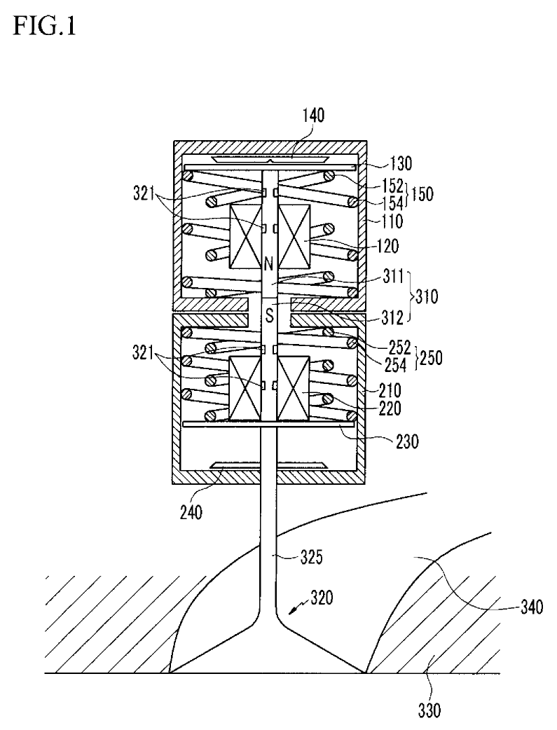

As shown in the drawings, a variable valve apparatus of an engine according to an exemplary embodiment of the present invention, where FIG. 1 shows a lower housing 210; an upper electromagnet such as a coil 120 that is fixed in the upper housing 110; a lower electromagnet such as a coil 220 that is fixed in the lower housing 210; a permanent magnet 310 that penetrates the upper coil 120 and the lower coil 220; an intake or exhaust valve 320 that has a valve stem 325 below the permanent magnet 310; an upper plate 130 that is arranged above the permanent magnet 310; and a lower plate 230 below the permanent magnet 310.

The valve 320 controls the introduction of an air/fuel mixture, or the expelling of exhaust, through an intake or exhaust port 340 in a cylinder head 330. The variable valve apparatus controls the operation of the valve 320.

The permanent magnet 310 has an N-pole 311 and an S-pole 312, aligned along the longitudinal direction of the valve stem 325 of the valve 320. For example, FIG. 1 illustrates that the N-pole 311 is above the S-pole 312.

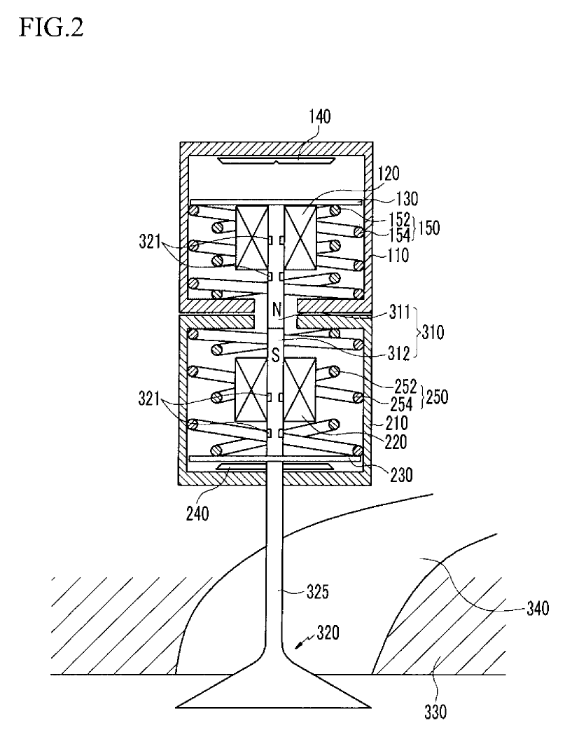

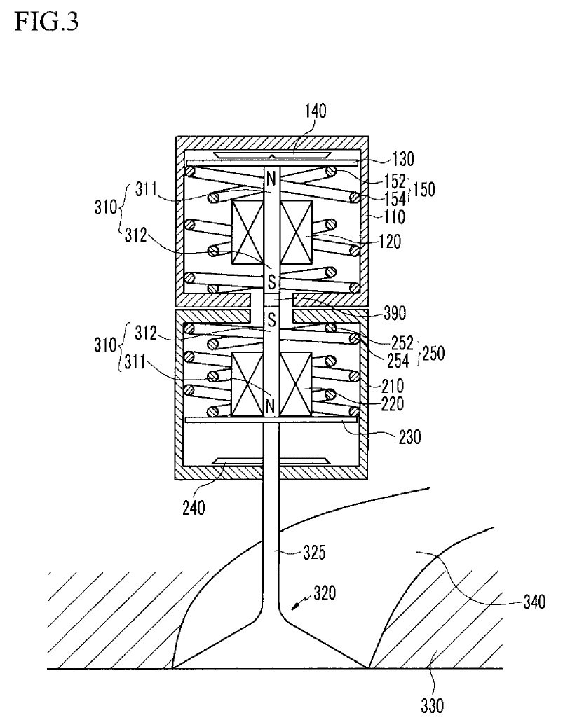

A metal ring 321 (FIGS. 2 and 3) is provided around the permanent magnet 310, such as by being press-fit at the circumference of each pole 311 and 312.

According to an exemplary embodiment, the permanent magnet 310 makes up the interior core of the coils 120 and 220. Therefore, performance of the variable valve apparatus is exceptional since the magnetic field inside the core is high.

The variable valve apparatus also includes an upper coil spring assembly 150 mounted outside the upper coil 120, between the upper plate 130 and the bottom of the upper housing 110; and a lower coil spring assembly 250 mounted outside the lower coil 220, between the lower plate 230 and the top of the lower housing 210.

When the valve 320 is being opened from the position shown in FIG. 1 to that shown in FIG. 2 by interaction between the permanent magnet 310 and the upper and lower coils 120 and 220, the lower coil spring assembly 250 assists the opening of the valve 320 by applying an elastic force to the lower plate 230 while the upper coil spring assembly 150 is compressed. When the valve is being closed, the upper coil spring assembly 150 assists the closing by applying an elastic force to the upper plate 130, while the lower coil spring assembly is compressed.

Since the coil spring assemblies 150 and 250 are provided to the sides of the coils 120 and 220, the length of the apparatus may be small.

The upper coil spring assembly 150 may have a dual spring structure having an interior coil spring 152 and an exterior coil spring 154. Also, the lower coil spring assembly 250 may have a dual spring structure having an interior coil spring 252 and an exterior coil spring 254. This allows for diversity of elastic coefficients and smooth movement of the valve 320.

The variable valve apparatus may further include an upper damper 140 at an upper interior surface of the upper housing 110; and a lower damper 240 at a lower interior surface of the lower housing 210. The dampers 140, 240 may be, for example, plate springs, and reduce impact to the valve 320 when the valve 320 is fully opened or closed.

The upper housing 110 and the lower housing 210 may be filled with oil, which damps the upper and lower plates 130, 230 in a manner used in the art, for example in hydraulic shock absorbers for suspension systems.

Operation of the valve 320 will now be described.

To open the valve 320 when it is closed, current is applied to the upper coil 120, which generates a magnetic field. The magnetic field acts on the permanent magnet 310 to supply downward force to the valve 320. When the valve 320 has moved down by a predetermined distance, the current to the upper coil 120 is cut, and current is applied to the lower coil 220, such that the lower coil 220 and the permanent magnet 310 have different polarities and the valve 320 is stopped by the magnetic interaction.

To close the valve 320, a current opposite that used for opening the valve 320 is applied to the upper coil 120, such that an upward force is applied to the valve by the interaction between the permanent magnet 310 and the electric field generated by the upper coil 120. When the valve 320 has moved up by a predetermined distance, the current to the upper coil 120 is cut, and current opposite that used for opening the valve 320 is applied to the lower coil 220, such that the lower coil 220 and the permanent magnet 310 have different polarities and the valve 320 is stopped by the magnetic interaction.

Alternatively, the current applied to the upper coil 120 or lower coil 220 may be a pulse width modulation (PWM) signal, such that the valve 320 may be stopped at an intermediate position. This obviates the need for the secondary, stopping current.

The exemplary apparatus can control valve lift and/or valve timing of the valve 320. Intake timing, exhaust timing, and/or intake air amount can thus be controlled without employing a camshaft, providing a decreased weight of the engine compared to the prior art.

A typical throttle valve may also not be necessary, since the air intake amount can be controlled by the exemplary apparatus.

Referring to FIG. 3, an alternative exemplary apparatus includes several permanent magnets 310, each having an S-pole 312 and an N-pole 311. A metal piece 390 may be provided between the permanent magnets 310, which allows the polarities of the permanent magnets 310 to be oriented such that poles of the same polarity (S-pole in FIG. 3) may face the metal piece, as shown in FIG. 3

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. An apparatus configured to be mounted above a valve stem of a valve and to open and close the valve, the apparatus comprising:
an upper housing and a lower housing;
an upper electromagnet in the upper housing;
a lower electromagnet in the lower housing;
at least one permanent magnet that penetrates the electromagnets;
an upper plate between the permanent magnet and the upper housing; and
a lower plate between the permanent magnet and the lower housing, configured to open and close the valve.

2. The variable valve apparatus of claim 1, further comprising an upper coil spring assembly mounted in the upper housing, and a lower coil spring assembly mounted in the lower housing.

3. The variable valve apparatus of claim 2, wherein the upper and lower coil spring assemblies each comprise at least two coil springs.

4. The variable valve apparatus of claim 1, further comprising an upper damper at a top of the upper housing, and a lower damper at a bottom of the lower housing.

5. The variable valve apparatus of claim 1, further comprising oil disposed in the upper and lower housings.

6. An apparatus configured to be mounted above a valve stem of a valve and to open and close the valve, the apparatus comprising:
a housing;
an electromagnet in the housing;
at least one permanent magnet that penetrates the electromagnet; and
upper and lower plates disposed above and below the permanent magnet, respectively, where the lower plate is configured to open and close the valve.

7. A variable valve apparatus of an engine, comprising:
an upper housing and a lower housing;
an upper coil that is fixed within the upper housing;
a lower coil that is fixed within the lower housing;
a permanent magnet that penetrates the upper coil and the lower coil;
a valve having a valve stem positioned below the permanent magnet;
an upper plate that is positioned above the permanent magnet; and
a lower plate that is positioned between the permanent magnet and the valve stem.

8. The variable valve apparatus of claim 7, further comprising:
an upper coil spring assembly that is mounted exterior to an outer circumference of the upper coil and between the upper plate and a bottom side of the upper housing; and
a lower coil spring assembly that is mounted exterior to an outer circumference of the lower coil and between the lower plate and a top side of the lower housing.

9. The variable valve apparatus of claim 8, wherein the upper coil spring assembly and the lower coil spring assembly are formed as a dual spring structure having interior and exterior coil springs.

10. The variable valve apparatus of claim 7, further comprising:
an upper damping device arranged at an upper interior surface of the upper housing; and
a lower damping device arranged at a lower interior surface of the lower housing.

11. The variable valve apparatus of claim 8, further comprising:
an upper damping device arranged at an upper interior surface of the upper housing; and
a lower damping device arranged at a lower interior surface of the lower housing.

12. The variable valve apparatus of claim 7, wherein the upper housing and the lower housing are filled with oil.

13. The variable valve apparatus of claim 8, wherein the upper housing and the lower housing are filled with oil.

14. The variable valve apparatus of claim 10, wherein the upper housing and the lower housing are filled with oil.

15. The variable valve apparatus of claim 12, wherein a damping effect is generated by the oil when the upper plate moves and when the lower plate moves.

16. The variable valve apparatus of claim 13, wherein a damping effect is generated by the oil when the upper plate moves and when the lower plate moves.

17. The variable valve apparatus of claim 14, wherein a damping effect is generated by the oil when the upper plate moves and when the lower plate moves.
